(19) United States
(12) Patent Application Publication
(10) Pub. No.: US 2002/0170163 A1
(43) Pub. Date: Nov. 21, 2002

(54) Dished disk windings for cast winding applications

(76) Inventor: Jeewan Puri, Matthews, NC (US)

Correspondence Address: Larry I. Golden, Square D Company, 1415 South Roselle Road, Palatine, IL, 60067, US

(21) Appl. No.: 10/090,189

(22) Filed: Mar. 4, 2002

Related U.S. Application Data
(62) Division of application No. 09/723,180, filed on Nov. 27, 2000.

(51) Int. Cl. H01F 7/06

(52) U.S. Cl. 29/602.1

(57) ABSTRACT

The present invention is a dry type transformer having a plurality of winding disks wound in a first direction alternating with a plurality of winding disks wound in a reverse direction. The winding disks are connected by alternating Start to Start, and Finish to Finish connections. One set of the winding disks are dished to shorten the distance for the connections.

### RELATED APPLICATIONS

This application is a divisional of U.S. patent application Ser. No. 09/723,180, filed Nov. 27, 2000, which is hereby incorporated by reference, and made a part hereof.

It should also be noted that this application is related to application Ser. No. 09/723,181, filed Nov. 27, 2000, which is commonly assigned, has a common inventor, and is further hereby incorporated by reference.

While specific embodiments have been illustrated and described, numerous modifications are possible without departing from the spirit of the invention, and the scope of protection is only limited by the scope of the accompanying claims.

### TECHNICAL FIELD

The present invention is generally directed to a dry type transformer and to a method of making the transformer, and more particularly to a dry type transformer wherein each alternate winding disk is reverse wound so that alternating Start to Start, and Finish to Finish connections connect the winding disks and to a method of forming such a transformer.

### BACKGROUND OF THE INVENTION

The use of disk type High Voltage cast windings with foil-type conductors is becoming popular in dry-type transformers. In such transformers, all of the winding disks have a Start and a Finish, and are wound in the same direction. Such winding disks are interconnected using Start to Finish connections. However, for mechanical reasons, such windings require a sufficient amount of disk to disk space (typically at least ¾ inches) for routing the Start to Finish disk to disk connection.

The number of disks used in a transformer winding of the type described above is kept to a minimum in order to minimize the labor cost of the transformer. However, this results in a large number of turns in each disk of the High voltage coil. Additionally, this type of winding design configuration yields a higher ratio of the winding to ground capacitance and the effective series capacitance of the winding. This is a characteristic that produces a non-linear impulse voltage distribution at the Star to Finish disk to disk connections. Also, the use of a relatively larger number of turns in this type of coil design produces oscillations in the disk to disk transient voltages due to lightning impulses.

In order to avoid some of the problems associated with the prior designs, it is highly desirable to create a transformer coil having a more linear impulse voltage distribution. In this regard, the design of the present invention results in a relatively higher effective series capacitance of the winding, thus making the disk to disk impulse voltage distribution more linear. Moreover, in accordance with certain aspects of the present invention, the voltage withstand capability of the winding can be greatly increased without adding to the length of the coil. This design can also be very useful in extending the BIL margins in all the voltage ratings of the transformers.

### SUMMARY OF THE INVENTION

The present invention is directed to a transformer coil having Start to Start, and Finish to Finish connections between adjacent disks of the High Voltage windings. Each alternate disk in this design is reverse wound for obtaining proper polarity for these connection. Since there is no voltage difference a the Start to Start, and Finish to Finish connections, very little disk to disk distance is needed at these locations. Therefore the required distance between the Start and Finish connections of the adjacent disks can be provided by simply “dishing” the reverse wound disks. This results in reducing the length of the coil while the voltage withstand capability of the winding remains unchanged.

The use of Start to Start, and Finish to Finish connections increases the effective series capacitance of the winding while not influencing the winding to ground capacitance. This results in a more linear impulse distribution at the disk to disk connections (i.e., either Start to Start, or Finish to Finish).

The use of a relatively large number of turns in the disks can produce oscillations that may require additional space between specific pairs of disks at strategic locations. Accordingly, some of the saved coil length resulting from use of the connections described herein, may therefore be used to increase the Start to Finish space between the adjacent disks at such locations, thereby enhancing the voltage withstand capabilities while making the windings more cost efficient at the same time.

In accordance with one embodiment of the invention, a transformer comprises a first winding disk having a Start and a Finish, a second winding disk having a Start and a Finish; and a Start to Start connection connecting the Start of the first winding disk to the Start of the second winding disk. Additionally, the transformer can further comprise a third winding disk having a Start and a Finish, and, a Finish to Finish connection connecting the Finish of the second winding disk to the Finish of the third winding disk. In such transformers, each alternate disk is reverse wound. For example, the first winding disk and the third winding disk are wound clockwise, and the second winding disk is wound counterclockwise.

The Start of the first winding disk is separated by less than 0.75 inches from the Start of the second winding disk. In some transformers, the Start of the first winding disk is separated by less than 0.50 inches from the Start of the second winding disk. Similarly, the Finish of the second winding disk is separated by less than 0.75 inches from the Finish of the third winding disk. Again, in some transformers the Finish of the second winding disk is separated by less than 0.50 inches from the Finish of the third winding disk.

To decrease the separation distance alternate winding disks can be dished. For example, in one embodiment the second winding disk of a transformer having at least three disks is dished.

The transformer may further comprise a fourth winding disk having a Start and a Finish, and, a Start to Start connection connecting the Start of the third winding disk to the Start of the fourth winding disk. In such transformer the fourth winding disk can be dished. Additionally, the transformer may include additional winding disks having Start to Start, and Finish to Finish connections in accordance with this invention. The transformer may be a dry type transformer wherein the winding disks are encased in resin.

In another embodiment, a dry type transformer comprises a first plurality of winding disks, each of the first plurality of winding disks having a Start and a Finish, and wherein the first plurality of winding disks being wound in a first direction, a second plurality of winding disks alternately disposed between consecutive winding disks of the first plurality of winding disks, each of the second plurality of winding disks having a Start and a Finish, and wherein the second plurality of winding disks being wound in a second direction reverse from the first direction of the first plurality of winding disks, a plurality of Start to Start connections, each Start to Start connection connecting a Start of one of the winding disks of the first plurality of winding disks to a Start of one of the winding disks of the second plurality of winding disks, and a plurality of Finish to Finish connections, each Finish to Finish connection connecting a Finish of one of the winding disks of the second plurality of winding disks to a Finish of one of the winding disks of the first plurality of winding disks, wherein the plurality of Start to Start connections alternate with the plurality of Finish to Finish connections. The first direction may be clockwise, and the second direction may be counter clockwise, or vice versa. Also, the second plurality of winding disks may be dished.

In one form of this embodiment, at least one of the Start to Start connections maintains a separation of less than 0.75 inches between a Start of one of the winding disks of the first plurality of winding disks from a Start of one of the winding disks of the second plurality of winding disks. In some cases, at least one of the Start to Start connections maintains a separation of less than 0.50 inches between a Start of one of the winding disks of the first plurality of winding disks from a Start of one of the winding disks of the second plurality of winding disks.

In yet another embodiment of the invention, a method of forming a transformer comprises the steps of: providing a first winding disk wound in a first direction and having a Start and a Finish; providing a second winding disk wound in a second direction reversed from the first direction and having a Start and a Finish; and, electrically connecting the Start of the first winding disk to the Start of the second winding disk. Additionally, the method comprises providing a third winding disk wound in the first direction and having a Start and a Finish; and, electrically connecting the Finish of the second winding disk to the Finish of the third winding disk. The method may further include providing additional disks to maintain a Start to Start, and Finish to Finish connections of the disks. Also, the method may further comprise dishing the second winding disk (and in the case of more than three disks, the method could comprise dishing alternate disks).

Further aspects of the invention are disclosed in the detailed description of the preferred embodiment, the drawings and the claims.

### BRIEF DESCRIPTION OF THE DRAWINGS

FIG. 1 is a partial cross-sectional view of a dry type transformer made in accordance with the prior art;

FIG. 2 is a partial cross-sectional view of a transformer made in accordance with the present invention; and,

FIG. 3 is an end view of the disk connections of the transformer of FIG. 2.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

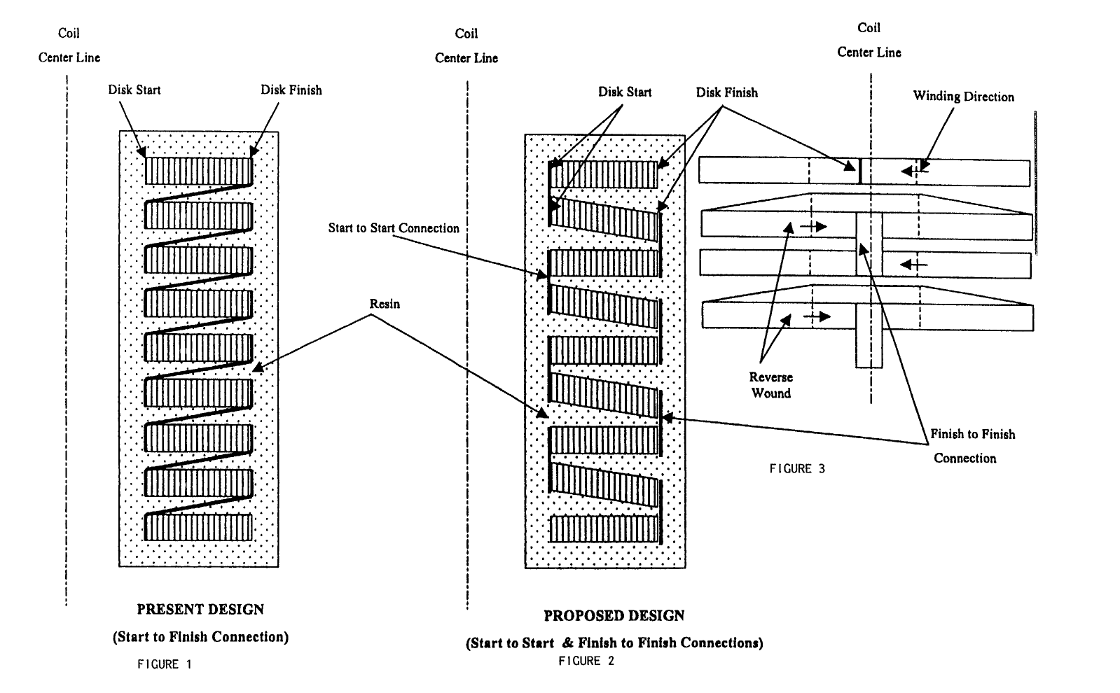

Prior art dry type transformers 10, as shown in cross-section in FIG. 1, include a plurality of identical winding disks 12 vertically aligned about a coil center line 16 of the transformer 10. The winding disks 12 are encased in a resin 14.

Each of the winding disks 12 includes a Start 18 and a Finish 20. Moreover, each of the winding disks 12 are wound in the same direction and are positioned as shown in FIG. 1, so that all of the Starts 18 and Finishes 20 of the winding disks 12 are axially aligned, one above the next. Start to Finish disk to disk connections 22 are then used to electrically connect consecutive winding disks 12. Specifically, the Start 18 of a first winding disk 12 (at the bottom of the transformer) is connected to the Finish 20 of the winding disk 12 immediately above the first winding disk 12. Similar Start to Finish disk to disk connections 22 are used to electrically connect all of the winding disks 12 in the stack.

As is evident from FIG. 1, because the Start 18 of one disk 12 is at the opposite side from the Finish 20 of a next disk 12, the Start to Finish connection 22 must cross over the entire span of the winding disk 12, at an angle relative to the center coil line, to make the electrical connection between consecutive disks. This requires sufficient routing space, approximately ¾ inches, to allow room for implementation of the connection 22. Additionally, placement of the connection in this manner across the disk windings effects the impulse voltage between winding disks.

In the preferred embodiment of the invention, a transformer 30 is also formed with a number of winding disks encased in resin 32, as shown in partial cross-section in FIG. 2. However, unlike the prior art, the transformer 30 of the present invention includes a first set of a plurality of winding disks 34, and a second set of a plurality of winding disks 36 alternately disposed between the first set of winding disks 34.

The winding disks 34 from the first set include a Start 38 and a Finish 40. Similarly, the winding disks 36 of the second set include a Start 42 and a Finish 44.

Each of the first set of winding disks 34 are wound in the same direction (e.g., all clockwise). However, each of the second set of winding disks 36 are wound in the opposite direction (e.g., counterclockwise).

Similar to the prior art transformer 10, each of the first set of winding disks 34 and the second set of winding disks 36 are positioned, one above the other, with the Start and the Finish aligned. However, because each alternate winding disk is wound in a different direction, the Start from one winding disk can be connected to the Start of a second winding disk rather than the Finish. Similarly, the Finish of one winding disk can be connected to the Finish of a second winding disk. Such connections (i.e., Start to Start, and Finish to Finish) can alternate through the stack of winding disks.

Referring to FIG. 2, Starting at the top of the stack of winding disks 34, 36, a first Start to Start connection 46 is shown connecting the Start 38 of the winding disk 34 from the first set of winding disks 34 to the Start 42 of a winding disk 36 from the second set of winding disks 36. Moving downward, a Finish to Finish connection 48 connects the Finish 44 of the winding disk 36 from the first set of winding disks 36 to the Finish 40 of the next winding disk 34 from the first set of winding disks 34. This pattern (of connections) continues throughout the stack.

It is evident that use of the Start to Start and Finish to Finish connections 46, 48 does not require the disk to disk connection to traverse from one side of the winding disk to the other as in the prior art. Additionally, this allows for placement of the Start 38 of winding disk 34 from the first set to be placed close to the Start 42 of the winding disk 36 from the second set. Similarly, a Finish 40 from a winding disk 34 of the first set can be positioned close to a Finish 44 of a winding disk 36 of the second set. This allows the Start to Start and Finish to Finish connections 46, 48 to be very short, which in turn, allows the Start of one winding disk to be positioned a shorter distance from a Start of another winding disk than allowed in the prior art. Similarly, a Finish of one winding disk can be positioned a shorter distance from the Finish of a second winding disk. The distance between the winding disks can be less than ¾ inches, and in some cases less than 0.5 inches.

To accomplish this, each of the alternate winding disks 36 (i.e., the second set) can be dished to bring the Start 42 and Finish 44 closer to the respective Start 38 and Finish 40 of the winding disks 34 from the first set. The savings in space from reducing the distance between connections can used to strategically allow a greater distance at certain locations in the stack as appropriate.

FIG. 3 shows an end view of winding disks 34, 36 from FIG. 2. It is evident from this Figure that each alternate winding disk is wound in the opposite direction.

As mentioned above the Start to Finish type of disk to disk connection requires a minimum axial separation for mechanical reasons, between disks for routing these connections (see FIG. 1). This spacing (approximately 0.75 inches) is far more than what is required to withstand the voltage produced by one disk. In the transformer 30 constructed in accordance with the present invention, only half as many disk to disk separations are necessary. Unlike in the present design, the space between the Start and Finish ends of the adjacent disks has to withstand the sum of the voltage produced by both the disks. This normally will require less space than what is presently being provided for mechanical reasons. Thus, the overall length of the coil can be decreased without decreasing its voltage withstand capability, or conversely, the voltage withstand capability of the transformer can be greatly increased by the using the design of this invention without changing its length.

I claim:

1. A method of forming a transformer comprising the steps of:
providing a first winding disk wound in a first direction and having a Start and a Finish;
providing a second winding disk wound in a second direction reversed from said first direction and having a Start and a Finish; and,
electrically connecting said Start of said first winding disk to said Start of said second winding disk.

2. The method of claim 1 further comprising the steps of:
providing a third winding disk wound in said first direction and having a Start and a Finish; and,
electrically connecting said Finish of said second winding disk to said Finish of said third winding disk.

3. The method of claim 2 further comprising dishing said second winding disk.
